(19) United States
(12) Patent Application Publication
(10) Pub. No.: US 2015/0100669 A1
(43) Pub. Date: Apr. 9, 2015

(54) CONTROL DEVICE AND METHOD FOR OPERATING SAME, AND SERVER AND METHOD FOR OPERATING SAME

(71) Applicant: LG ELECTRONICS INC., Seoul (KR)

(72) Inventors: Seungryul Yang, Seoul (KR); Minsoo Lee, Seoul (KR); Jeonghwan Yoon, Seoul (KR); Jaekoo Lee, Seoul (KR); Jangwoong Park, Seoul (KR); Hyeonjae Lee, Seoul (KR); Jongyeop Lee, Seoul (KR)

(73) Assignee: LG ELECTRONICS INC., Seoul (KR)

(21) Appl. No.: 14/385,853

(22) PCT Filed: Mar. 13, 2013
(86) PCT No.: PCT/KR2013/002014

§ 371 Date: Sep. 17, 2014

Related U.S. Application Data
(60) Provisional application No. 61/612,377, filed on Mar. 18, 2012.

(51) Int. Cl. H04L 29/06

(52) U.S. Cl. CPC H04L 65/60; H04L 67/42
USPC 709/219

(57) ABSTRACT

A method for operating a server controlled by a control device, according to an embodiment may include determining whether metadata of media content has been changed, and transmitting a metadata change information message to the control device when it is determined that the metadata of the media content has been changed, wherein the metadata change information message may include metadata change notification information for notifying that the metadata of the media content has been changed.

### TECHNICAL FIELD

The present disclosure relates to a control device and a method for operating the same, and a server and a method for operating the same.

### BACKGROUND ART

A universal plug and play (UPnP) technology and a digital living network alliance (DLNA) technology enable electronic devices of various manufactures to provide services to each other and control each other. In particular, the UPnP technology enables provision and control of audio-visual (AV) services compatible between AV devices. The compatible AV services include media steaming, uploading and downloading.

The DLNA regulates home network devices such as a digital media server (DMS), a digital media player (DMP), a digital media renderer (DMR), a digital media controller (DMC), and a digital media printer (DMPr), and regulates mobile devices such as a mobile digital media server (M-DMS), a mobile digital media player (M-DMP), a mobile digital media uploader (M-DMU), a mobile digital media downloader (M-DMD), and a mobile digital media controller (M-DMC).

Hereinafter, the DMS also refers to the M-DMS, the DMP also refers to the M-DMP, and the DMC also refers to the M-DMC.

The UPnP technology classifies such devices into control point (CP) devices and control target devices. The DMC and DMP may be classified as CP devices, and the DMR, DMS, and DMPr may be classified as control target devices.

The DLNA technology defines a 2-box model and a 3-box model.

The 2-box model includes the DMP and the DMS. In the 2-box model, the DMP enables a user to search for and play content browsed and distributed by the DMS.

The 3-box model includes the DMC, the DMS, and the DMR. In the 3-box model, the DMC enables the user to search for content of the DMS to be played in the DMR.

Devices compliant with the UPnP and DLNA technologies send and receive commands through internet protocol (IP) networking. That is, one of AV devices connected to the same network may provide an AV service to another device, may receive an AV service from another device, may control another device, or may be controlled by another device.

However, according to the related art, in the case where metadata is changed due to addition of media content, deletion of the media content or modification to a metadata property of the media content, a media service may only recognize an identifier of the media content of which the metadata has been changed and whether the metadata has been changed. Therefore, a control device should send an additional request to the media server in order to collect changed metadata, causing network traffic congestion and unnecessary consumption of resources of devices.

Furthermore, according to the related art, while the control device collects the changed metadata, the control device requests the entire metadata of media content that has been modified and receives the entire metadata of the media content, causing network traffic congestion and unnecessary consumption of resources of devices.

### DISCLOSURE OF THE INVENTION

### Technical Problem

Embodiments are directed to preventing network traffic congestion and saving device resources by efficiently transferring, to another device, changes of media content stored in a device for providing various network services.

### Technical Solution

In one embodiment, a method for operating a server controlled by a control device includes determining whether metadata of media content has been changed, and transmitting a metadata change information message to the control device when it is determined that the metadata of the media content has been changed, wherein the metadata change information message includes metadata change notification information for notifying that the metadata of the media content has been changed.

The metadata change notification information may include an identifier of the media content of which the metadata has been changed and a type of a changed metadata property among a plurality of metadata properties of the media content identified by the identifier.

The metadata change notification information may not include a type of a metadata property that has not been changed among the plurality of metadata properties of the media content identified by the identifier.

The metadata change information message may include metadata change value information, wherein the metadata change value information may include an identifier of the metadata change notification information and a changed value of a metadata property corresponding to a type of a metadata property of the metadata change notification information.

The metadata change value information may not include a value of a metadata property corresponding to a type of an unchanged metadata property of the media content identified by the identifier.

The transmitting step that transmits the metadata change information message to the control device may include checking whether the metadata change value information is set to be transmitted, wherein if the metadata change value information is set not to be transmitted, the metadata change information message may include the metadata change notification information, and if the metadata change value information is set to be transmitted, the metadata change information message may include the metadata change notification information and the metadata change value information.

The method may include receiving, from the control device, a metadata change value request message for requesting metadata change value information, and transmitting a metadata change value information response message to the control device in response to the metadata change value request message, wherein the metadata change value information may include an identifier of the metadata change notification information and a changed value of a metadata property corresponding to a type of a metadata property of the metadata change notification information.

The metadata change information message may include the metadata change notification information and metadata change value information, wherein the metadata change notification information may indicate that new media content is added to the server and there exists metadata of the added media content, the metadata change notification information including an identifier of the added media content, wherein the metadata change value information may include a plurality of metadata properties of the added media content and values of the plurality of metadata properties.

In another embodiment, a method for operating a control device for controlling a server includes transmitting, to the server, a request for metadata of a plurality of media contents, receiving, from the server, the metadata of the plurality of media contents in a response to the request, and receiving a metadata change information message about whether the metadata of at least one of the plurality of media contents has been changed or whether there exists media content added to the server, wherein the metadata change information message includes metadata change notification information for notifying that the metadata of the media content has been changed.

When the metadata of at least one of the plurality of media contents is changed, the metadata change notification information may include an identifier of the media content of which the metadata has been changed and a type of a changed metadata property among a plurality of metadata properties of the media content identified by the identifier.

The metadata change information message may include metadata change value information, wherein the metadata change value information may include an identifier of the metadata change notification information and a changed value of a metadata property corresponding to a type of a metadata property of the metadata change notification information.

The method may include transmitting, to the server, a metadata change value request message for requesting metadata change value information, and receiving a metadata change value information response message from the server in response to the metadata change value request message, wherein the metadata change value information may include an identifier of the metadata change notification information and a changed value of a metadata property corresponding to a type of a metadata property of the metadata change notification information.

The method may include checking whether the type of the changed metadata property affects playback of the media content of which the metadata has been changed, on the basis of the type of the changed metadata property.

The method may include outputting that the playback of the media content of which the metadata has been changed is unavailable, if it is checked that the type of the changed metadata property affects the playback of the media content, and outputting that the playback of the media content of which the metadata has been changed is available, if it is checked that the type of the changed metadata property does not affect the playback of the media content.

If there exists media content added to the server, the metadata change information message may include the metadata change notification information and the metadata change value information, wherein the metadata change notification information may indicate that new media content is added to the server and there exists metadata of the added media content, the metadata change notification information including an identifier of the added media content, wherein the metadata change value information may include a plurality of metadata properties of the added media content and values of the plurality of metadata properties.

In further another embodiment, a server controlled by a control device includes a network interface, and a control unit configured to determine whether metadata of media content has been changed, and to transmit a metadata change information message to the control device through the network interface when it is determined that the metadata of the media content has been changed, wherein the metadata change information message includes metadata change notification information for notifying that the metadata of the media content has been changed.

In still further another embodiment, a control device for controlling a server includes a network interface, and a control unit configured to transmit, to the server, a request for metadata of a plurality of media contents through the network interface, to receive, from the server, the metadata of the plurality of media contents in a response to the request, and to receive a metadata change information message about whether the metadata of at least one of the plurality of media contents has been changed or whether there exists media content added to the server, wherein the metadata change information message includes metadata change notification information for notifying that the metadata of the media content has been changed.

### Advantageous Effects

According to embodiments, since only a value of a changed metadata property is received instead of receiving all the values of metadata properties of media content having changed metadata, the size of transmitted metadata may be reduced, thereby reducing unnecessary transmission of data. Therefore, the network traffic may be reduced, and network resources may be saved.

In the case where a metadata change information message includes metadata change notification information and metadata change value information, a control device may receive the metadata change value information of media content without additionally requesting the metadata change value information from a server, thereby reducing the network traffic.

Other various effects will be explicitly or implicitly disclosed in the following detailed description.

### BRIEF DESCRIPTION OF THE DRAWINGS

FIG. 1 is a ladder diagram illustrating a method for operating a control device and a server according to an embodiment.

FIGS. 2 to 5 are ladder diagrams illustrating methods for operating the control device and the server in the case where metadata of media content is modified, according to embodiments.

FIG. 6 is a ladder diagram illustrating a method for operating the control device and the server in the case where the metadata of media content is added, according to an embodiment.

FIGS. 7 and 8 are diagrams illustrating an XML schema of metadata change notification information transmitted from the server to the control device when it is checked that an object of which the metadata has been modified exists.

FIGS. 9 and 10 are diagrams illustrating an XML schema of metadata change value information transmitted from the server to the control device when it is checked that an object of which the metadata has been modified exists.

FIGS. 11 and 12 illustrate an XML schema of a metadata change information message transmitted from the server to the control device when a new object is added to the server.

FIG. 13 is a block diagram illustrating devices according to an embodiment.

FIG. 14 is a block diagram illustrating a 2-box model device according to an embodiment.

FIG. 15 is a block diagram illustrating a 3-box model device according to an embodiment.

### MODE FOR CARRYING OUT THE INVENTION

Hereinafter, embodiments of the present disclosure will be described in detail with reference to the accompanying drawings so that those skilled in the art easily carry out the embodiments.

In the case where an embodiment of the present disclosure uses a digital living network alliance (DLNA) technology, a control device 100 may be one of a digital media controller (DMC) and a digital media player (DMP), and a server 200 may be one of a digital media renderer (DMR), a digital media server (DMS) and a digital media printer (DMPr).

In the case where an embodiment of the present disclosure uses a universal plug and play (UPnP) technology, the control device 100 may be a control point (CP) device, and the server may be a control target device.

Hereinafter, a content list may include a plurality of media contents, wherein each of media contents may be one of a video, an audio and an image.

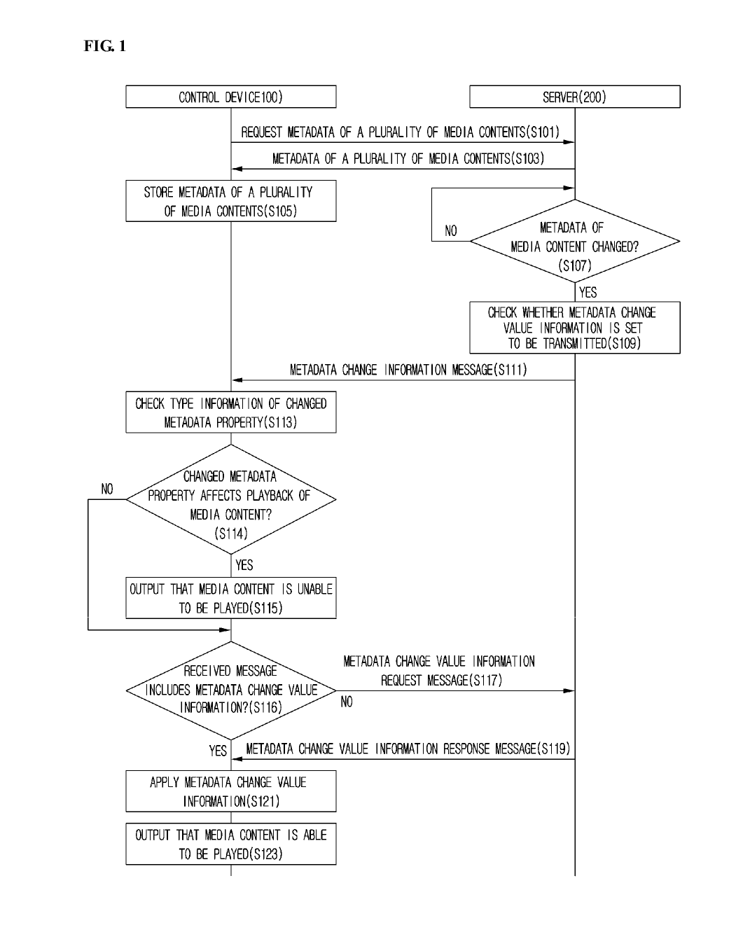

A method for operating a control device and a server according to an embodiment will be described with reference to FIG. 1.

FIG. 1 is a ladder diagram illustrating the method for operating the control device and the server according to an embodiment.

Referring to FIG. 1, the control device 100 requests metadata of a plurality of media contents from the server 200 (operation S101). In one embodiment, the metadata of the plurality of media content may include a plurality of metadata property sets. The plurality of metadata property sets may correspond to the plurality of media contents respectively. Each metadata property set may include information on a corresponding media content. That is, each metadata property set includes a plurality of metadata properties of a corresponding media content. The plurality of metadata properties may include information on an identifier of the corresponding media content, type information on a generation date of the corresponding media content, type information on a creator of the corresponding media content, type information on a title of the corresponding media content, type information on a size of the corresponding media content, type information on a genre of the corresponding media content, type information on a location of the corresponding media content, and type information on a media format of the corresponding media content.

The identifier of media content may represent information for distinguishing the media content from other media content.

The type information on the generation date of media content may indicate when the media content was generated.

The type information on the creator of media content may include a name of the creator of the media content.

The type information on the title of media content may represent a title of the media content.

The type information on the size of media content may represent the size of the media content.

The type information on the genre of media content may represent a genre to which the media content belongs.

The type information on the location of media content may indicate a location (URI/URL) of the media content.

The type information on the media format of media content may indicate a format of the media content, such as MPEG2, MPEG4, MP3, WMA or JPEG.

In one embodiment, the request for the metadata of the plurality of media contents, transmitted from the control device 100 to the server 200, may be a browsing command or a search command for obtaining the metadata of the plurality of media contents.

In response to the request of the control device 100 for the metadata of the plurality of media contents, the server 200 transmits the metadata of the plurality of media contents to the control device 100 (operation S103), and the control device 100 stores the metadata of the plurality of media contents received from the server 200 (operation S105).

Thereafter, the server 200 checks whether the metadata of media content has been changed (operation S107). That is, the server 200 may check which media content, among the plurality of media contents, has metadata that has been changed, or may check whether there is the metadata of new media content other than the plurality of media contents due to the addition of the new media content.

In one embodiment, the metadata of media content may be changed when a part or the entirety of a plurality of metadata properties included in the metadata property set corresponding to the media content is modified. In detail, the metadata of media content may be changed when a modification is made to a part or the entirety of the plurality of metadata properties corresponding to the media content. For example, when the type information on the location of media content is modified, the metadata of the media content may be modified, which may be the case where a part of the plurality of metadata properties of the media content is modified.

In another embodiment, the metadata of media content may be changed when new media content is additionally stored in the server 200 and the metadata property set corresponding to the new media content is added.

In another embodiment, the metadata of media content may be changed when media content is deleted from the server 200 and the metadata property set corresponding to the deleted media content is deleted.

When it is determined that the metadata of media content has been changed, the server 200 checks whether metadata change value information is set to be transmitted (operation S109). The metadata change value information will be described later.

In one embodiment, it may be determined, according to a setting of a user, whether the server 200 is set to transmit the metadata change value information. In detail, if the server 200 is set so that the user receives the metadata change value information when the metadata of media content is changed, the control device 100 may receive the metadata change value information of media content of which the metadata has been changed. If the server 200 is set so that the user does not receive the metadata change value information when the metadata of media content is changed, the control device 100 may not receive the metadata change value information of media content of which the metadata has been changed.

Thereafter, the server 200 transmits a metadata change information message to the control device 100 (operation S111). The metadata change information message may indicate whether the metadata of a plurality of media contents received from the server 200 has been changed or whether there is an added media content.

If the metadata change value information is set not to be transmitted, the metadata change information message may not include the metadata change value information but may include metadata change notification information. If the metadata change value information is set to be transmitted, the metadata change information message may include the metadata change notification information and the metadata change value information.

The metadata change notification information may indicate that the metadata of media content has been changed.

In one embodiment, the metadata change notification information may indicate that at least one of a plurality of media contents has been changed. The metadata change notification information may include information on the identifier of media content of which the metadata has been changed, and information on the type of a changed metadata property among the plurality of metadata properties of the media content identified by the identifier. In particular, the metadata change notification information may not include the information on the type of a metadata property that has not been changed among the plurality of metadata properties of the media content of which the metadata has been changed, but may only include the information on the type of a changed metadata property. In this case, the metadata change value information may be information on a changed value of the metadata property of at least one of a plurality of media contents. The metadata change value information may include changed values of the metadata properties corresponding to the identifier and type of the metadata change notification information. In particular, the metadata change value information may not include the value of a metadata property that has not been changed, but may only include the value of a changed metadata property.

In another embodiment, the metadata change notification information may indicate that there is the metadata of new media content added to the server 200. In this case, the metadata change notification information may include information on the identifier of the newly added media content, and the metadata change value information may include the plurality of metadata properties of the newly added media content and the values of the plurality of metadata properties.

In the case where the metadata change information message includes the metadata change notification information and the metadata change value information, the control device 100 may receive the metadata change value information of media content without additionally requesting the metadata change value information from the server 200, thereby reducing the network traffic. Furthermore, since the control device 100 may only receive the value of a changed metadata property instead of receiving all the values of the metadata properties of media content, the size of transmitted metadata may be reduced, thereby reducing unnecessary transmission of data. Therefore, the network traffic may be reduced, and network resources may be saved.

The control device 100 checks media content of which the metadata has been changed and the type information of a changed metadata property using the metadata change information message (operation S113). That is, the control device 100 may check media content of which the metadata has been changed and the type information of a changed metadata property using the metadata change notification information or the metadata change value information. In more detail, the control device 100 may check media content of which the metadata has been changed using the identifier of media content included in the metadata change notification information or the metadata change value information, and may check the type information of a changed metadata property among the plurality of metadata properties of the media content identified by the identifier.

Thereafter, the control device 100 checks whether the changed metadata property affects playback of media content, on the basis of the type information of the changed metadata property (operation S114). In one embodiment, if the control device 100 is able to directly play media content of which the metadata has been changed without an update of the changed metadata property, the control device 100 may check that the changed metadata property affects the playback of media content. Otherwise, the control device 100 may check that the changed metadata property does not affect the playback of media content. In detail, when the metadata property of one of the type information on the location of media content of which the metadata has been changed and the type information on the media format of media content of which the metadata has been changed is changed, the control device 100 may check that the changed metadata property affects the playback of media content, and when the metadata property of one of the type information on the generation date of media content of which the metadata has been changed, the type information on the creator of media content of which the metadata has been changed, the type information on the size of media content of which the metadata has been changed and the type information on the genre of media content of which the metadata has been changed is changed, the control device 100 may check that the changed metadata property affects the playback of media content.

If it is checked that the changed metadata property affects the playback of media content, the control device 100 outputs that media content of which the metadata has been changed is unable to be played (operation S115). That is, the control device 100 may output that the media content of which the metadata has been changed is unable to be played, until the updating of the media content of which the metadata has been changed is completed (until operation S121 described below is completed).

By virtue of the indication that the media content that has been changed is unable to be played, the user may intuitively determine that the media content has been changed.

Meanwhile, if it is checked that the changed metadata property does not affect the playback of media content, the control device 100 checks whether the metadata change information message received from the server 200 due to the change of the metadata includes the metadata change value information (operation S116).

If the metadata change information message received from the server 200 due to the change of the metadata of media content does not include the metadata change value information, the control device 100 transmits a metadata change value request message for requesting the metadata change value information to the server 200 (operation S117). In one embodiment, the metadata change value request message may include the identifier of media content of which the metadata has been changed and the type information of a changed metadata property, and the control device 100 may request the value of the changed metadata property of the media content identified by the identifier from the server 200. In another embodiment, the metadata change value request message may not include the identifier of media content of which the metadata has been changed and the type information of a changed metadata property, and the control device 100 may request all the values of changed metadata properties.

In response to the metadata change value request message, the server 200 transmits a metadata change value information response message including the metadata change value information to the control device 100 (operation S119). In operation S119, since the control device 100 may only receive the value of a changed metadata property instead of receiving all the values of the metadata properties of a changed media content among a plurality of media contents, the size of transmitted metadata may be reduced, thereby reducing unnecessary transmission of data. Therefore, the network traffic may be reduced, and network resources may be saved.

The control device 100 applies the metadata change value information received from the server 200 to a corresponding media content in a stored media content list (operation S121). That is, the control device 100 may only update media content of which the metadata has been changed among a plurality of media contents in the content list, without updating media contents which have not been changed.

Thereafter, the control device 100 outputs that the media content to which the metadata change value information is applied is able to be played (operation S123).

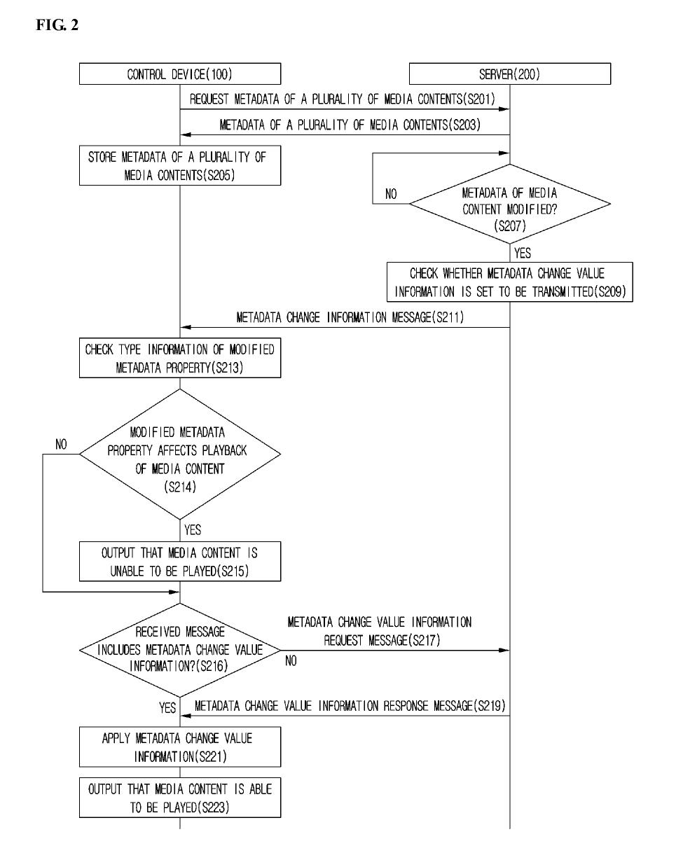

A method for operating a control device and a server according to another embodiment will be described with reference to FIGS. 2 to 5.

In particular, FIGS. 2 to 5 illustrate embodiments in which the metadata of media content is modified.

FIG. 2 is a ladder diagram illustrating the method for operating the control device and the server in the case where the metadata of media content is modified, according to another embodiment.

Referring to FIG. 2, the control device 100 requests the metadata of a plurality of media contents from the server 200 (operation S201).

In response to the request of the control device 100 for the metadata of the plurality of media contents, the server 200 transmits the metadata of the plurality of media contents to the control device 100 (operation S203), and the control device 100 stores the metadata of the plurality of media contents received from the server 200 (operation S205).

Thereafter, the server 200 checks whether the metadata of at least one of the plurality of media contents has been modified (operation S207). That is, the server 200 may check which one or more of the plurality of media contents stored in the server 200 has a metadata property set that has been changed. In one embodiment, the metadata of media content may be changed when a part or the entirety of a plurality of metadata properties included in the metadata property set corresponding to the media content is modified. For example, when the type information on the location of media content is modified, the metadata of the media content may be modified, which may be the case where one of the plurality of metadata properties of the media content is modified.

When it is determined that the metadata of at least one of the plurality of media contents has been modified, the server 200 checks whether the metadata change value information is set to be transmitted (operation S209).

In one embodiment, it may be determined, according to a setting of a user, whether the server 200 is set to transmit the metadata change value information. In detail, if the server 200 is set so that the user receives the metadata change value information when the metadata of at least one of the plurality of media contents is changed, the control device 100 may receive the metadata change value information of media content of which the metadata has been changed. If the server 200 is set so that the user does not receive the metadata change value information when the metadata of media content is changed, the control device 100 may not receive the metadata change value information of media content of which the metadata has been changed.

Thereafter, the server 200 transmits the metadata change information message to the control device 100 (operation S211). If the metadata change value information is set not to be transmitted, the metadata change information message may not include the metadata change value information but may include the metadata change notification information. If the metadata change value information is set to be transmitted, the metadata change information message may include the metadata change notification information and the metadata change value information.

The metadata change notification information may include information on the identifier of media content of which the metadata has been modified, and information on the type of a modified metadata property among the plurality of metadata properties of the media content identified by the identifier. In particular, the metadata change notification information may not include the information on the type of a metadata property that has not been modified among the plurality of metadata properties of the media content of which the metadata has been modified, but may only include the information on the type of a modified metadata property.

The metadata change value information may include modified values of the metadata properties corresponding to the identifier and type of the metadata change notification information. In particular, the metadata change value information may not include the value of a metadata property that has not been changed, but may only include the value of a modified metadata property.

In particular, in the case where the metadata change information message includes the metadata change notification information and the metadata change value information, the control device 100 may receive the metadata change value information of media content without additionally requesting the metadata change value information from the server 200, thereby reducing the network traffic. Furthermore, since the control device 100 may only receive the value of a modified metadata property instead of receiving all the values of the metadata properties of media content, the size of transmitted metadata may be reduced, thereby reducing unnecessary transmission of data. Therefore, the network traffic may be reduced, and network resources may be saved.

The control device 100 checks media content of which the metadata has been modified and the type information of a modified metadata property using the metadata change information message (operation S213). That is, the control device 100 may check media content of which the metadata has been modified and the type information of a modified metadata property using the metadata change notification information or the metadata change value information. In more detail, the control device 100 may check media content of which the metadata has been modified using the identifier of media content included in the metadata change notification information or the metadata change value information, and may check the type information of a modified metadata property among the plurality of metadata properties of the media content identified by the identifier.

Thereafter, the control device 100 checks whether the modified metadata property affects playback of media content, on the basis of the type information of the modified metadata property (operation S214).

If it is checked that the modified metadata property affects the playback of media content, the control device 100 outputs that media content of which the metadata has been modified is unable to be played (operation S215). That is, the control device 100 may output that the media content is unable to be played, until the modified metadata of the media content is applied to the content list of the control device 100. By virtue of the indication that the media content that has been changed is unable to be played, the user may intuitively determine that the media content has been changed.

Meanwhile, if it is checked that the changed metadata property does not affect the playback of media content, the control device 100 checks whether the metadata change information message received from the server 200 due to the modification to the metadata includes the metadata change value information (operation S216).

If the metadata change information message received from the server 200 due to the modification to the metadata of media content does not include the metadata change value information, the control device 100 transmits the metadata change value request message for requesting the metadata change value information (operation S217). In one embodiment, the metadata change value request message may include the identifier of media content of which the metadata has been modified and the type information of a modified metadata property, and the control device 100 may request the value of the modified metadata property of the media content identified by the identifier from the server 200. In another embodiment, the metadata change value request message may not include the identifier of media content of which the metadata has been modified and the type information of a modified metadata property, and the control device 100 may request all the values of modified metadata properties.

In response to the metadata change value request message, the server 200 transmits modified metadata to the control device 100 (operation S219). In operation S119, since the control device 100 may only receive the value of a modified metadata property instead of receiving all the values of the metadata properties of a modified media content among a plurality of media contents, the size of transmitted metadata may be reduced, thereby reducing unnecessary transmission of data. Therefore, the network traffic may be reduced, and network resources may be saved.

The control device 100 applies the metadata change value information received from the server 200 to a corresponding media content in the stored media content list (operation S221). That is, the control device 100 may only update media content of which the metadata has been modified among a plurality of media contents in the content list, without updating media contents which have not been modified.

Thereafter, the control device 100 outputs that the media content to which the metadata change value information is applied is able to be played (operation S223).

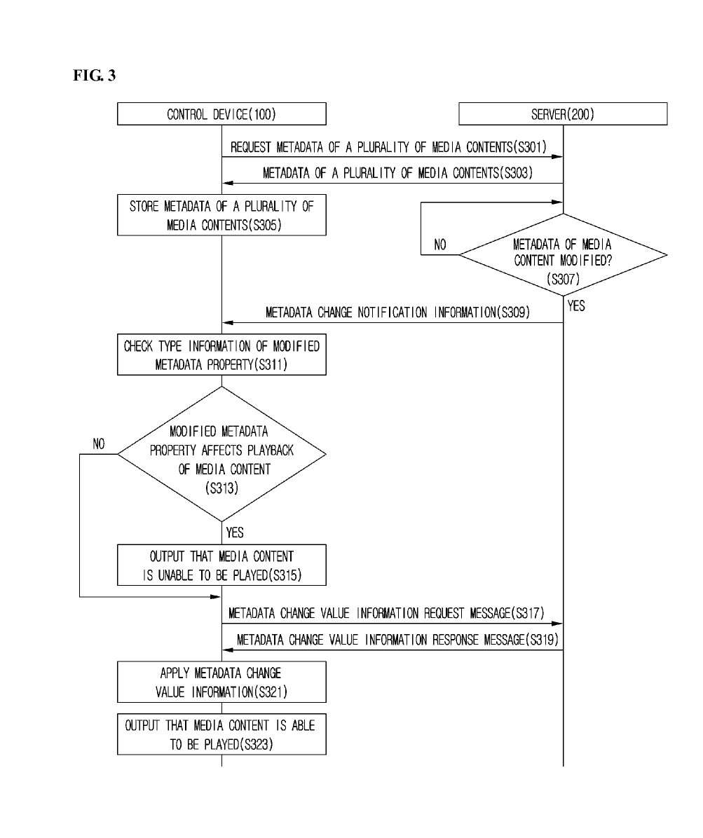

Next, FIG. 3 is described.

FIG. 3 is a ladder diagram illustrating a method of transmitting/receiving data between a control device and a server according to another embodiment.

In particular, FIG. 3 illustrates an embodiment in which, in the case where the metadata of media content is modified, the server 200 transmits, to the control device 100, the metadata change information message that does not include the metadata change value information but only includes the metadata change notification information. That is, in the embodiment, the server 200 transmits the metadata change notification information to the control device 100 when the metadata of media content is modified.

Referring to FIG. 3, the control device 100 requests the metadata of a plurality of media contents from the server 200 (operation S301).

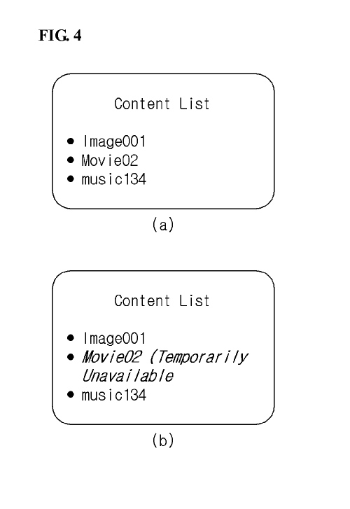

In response to the request of the control device 100 for the metadata of the plurality of pieces of metadata, the server 200 transmits the metadata of the plurality of media contents to the control device 100 (operation S303), and the control device 100 stores the metadata of the plurality of media contents received from the server 200 (operation S305). The control device 100 may display the plurality of media contents received from the server 200 on a user screen. In particular, the control device 100 may output through the user screen whether media content is able to be played. This operation will be described with reference to FIG. 4.

Thereafter, the server 200 checks whether the metadata of one of the plurality of media contents has been modified (operation S307). That is, the server 200 may check which one of the plurality of media contents stored in the server 200 has a metadata property set that has been changed. In one embodiment, the metadata of media content may be changed when a part or the entirety of a plurality of metadata properties included in the metadata property set corresponding to the media content is modified. For example, when the type information on the location of media content is modified, the metadata of the media content may be modified, which may be the case where one of the plurality of metadata properties of the media content is modified.

When it is checked that the metadata of one of the plurality of media contents has been modified, the server 200 transmits the metadata change notification information to the control device 100 (operation S309). The metadata change notification information may include information on the identifier of media content of which the metadata has been modified, and information on the type of a modified metadata property among the plurality of metadata properties of the media content identified by the identifier. In particular, the metadata change notification information may not include the information on the type of a metadata property that has not been modified among the plurality of metadata properties of the media content of which the metadata has been modified, but may only include the information on the type of a modified metadata property.

The control device 100 checks media content of which the metadata has been modified and the type information of a modified metadata property using the metadata change notification information (operation S311). That is, the control device 100 may check media content of which the metadata has been modified using the identifier of media content included in the metadata change notification information, and may check the type information of a modified metadata property among the plurality of metadata properties of the media content identified by the identifier.

Thereafter, the control device 100 checks whether the modified metadata property affects playback of media content, on the basis of the type information of the modified metadata property (operation S313).

If it is checked that the modified metadata property affects the playback of media content, the control device 100 outputs that media content of which the metadata has been modified is unable to be played (operation S315). This operation will be described with reference to FIG. 4.

FIG. 4 illustrates a user screen for indicating whether media content is able to be played according to an embodiment. In FIG. 4, the control device 100 displays, on the user screen, a content list including an image content Image001, a video content Movie02 and an audio content music1234.

FIG. 4A illustrates that all of the image content Image001, the video content Movie02 and the audio content music1234 are able to be played, and FIG. 4B illustrates that the image content Image001 and the audio content music1234 are able to be played, but the video content Movie02 is temporarily unable to be played.

In the case where the modified metadata property is type information on the location of media content that affects the playback of media content, and media content of which the metadata has been modified is the video content Movie02, the control device 100 may output through the user screen that media content of which the metadata has been modified is unable to be played. That is, as illustrated in FIG. 4B, the control device 100 may output that the video content Movie02 is temporarily unable to be played by displaying the wording “Temporarily Unavailable” at one side of the title of the video content. Therefore, the user may intuitively and easily apprehend that the video content is currently unable to be played. The control device 100 may output that the media content of which the metadata has been modified is unable to be played, until the modified metadata of the media content is applied to the content list.

If it is confirmed that the modified metadata property does not affect the playback of media content, the control device 100 may output that the playback of the video content is available as illustrated in FIG. 4A.

FIG. 3 is described again.

Meanwhile, if it is checked that the modified metadata property does not affect the playback of media content, the control device 100 transmits the metadata change value request message for requesting the metadata change value information (operation S317). In one embodiment, the metadata change value request message may include the identifier of media content of which the metadata has been modified and the type information of a modified metadata property, and the control device 100 may request the value of the modified metadata property of the media content identified by the identifier from the server 200. In another embodiment, the metadata change value request message may not include the identifier of media content of which the metadata has been modified and the type information of a modified metadata property, and the control device 100 may request all the values of modified metadata properties.

In response to the metadata change value request message, the server 200 transmits the metadata change value information response message to the control device 100 (operation S319). In operation S319, since the control device 100 may only receive the value of a modified metadata property instead of receiving all the values of the metadata properties of a modified media content among a plurality of media contents, the size of transmitted metadata may be reduced, thereby reducing unnecessary transmission of data. Therefore, the network traffic may be reduced, and network resources may be saved.

The control device 100 applies the metadata change value information received from the server 200 to a corresponding media content in a stored media content list (operation S321).

Thereafter, the control device 100 outputs that the media content to which the metadata change value information is applied is able to be played (operation S323). Referring to FIG. 4, in the case where the value of the modified metadata property of the video content Movie02 is applied to the media content list, the control device 100 may delete the indication that the playback of media content is unavailable, and may output that the video content to which the value of the modified metadata property is applied is able to be played as illustrated in FIG. 4A. Alternatively, in the case where the value of the modified metadata property of the video content Movie02 is applied to the media content list, the control device 100 may display the wording “available” at one side of the title of the video content. Therefore, the user may intuitively and easily apprehend that the updating of media content of which the metadata has been modified is completed.

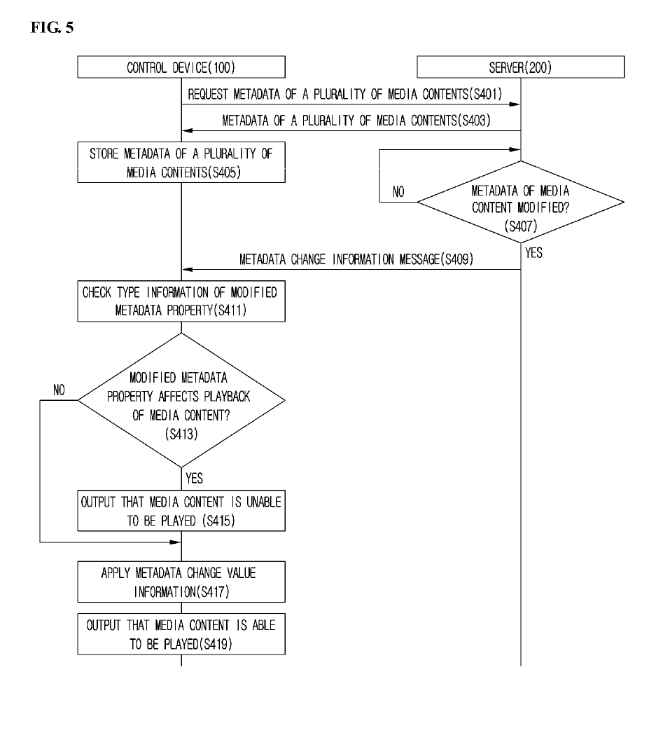

Next, FIG. 5 is described.

FIG. 5 is a ladder diagram illustrating a method for operating a control device and a server according to another embodiment.

In particular, FIG. 5 illustrates an embodiment in which, in the case where the metadata of media content is modified, the server 200 transmits, to the control device 100, the metadata change information message including the metadata change notification information and the metadata change value information.

Referring to FIG. 5, the control device 100 requests the metadata of a plurality of media contents from the server 200 (operation S401).

In response to the request of the control device 100 for the metadata of the plurality of pieces of metadata, the server 200 transmits the metadata of the plurality of media contents to the control device 100 (operation S403), and the control device 100 stores the metadata of the plurality of media contents received from the server 200 (operation S405).

Thereafter, the server 200 checks whether the metadata of the media content stored in the server 200 has been modified (operation S407). That is, the server 200 may check which one of the plurality of media contents stored in the server 200 has a metadata property set that has been changed. In one embodiment, the metadata of media content may be changed when a part or the entirety of a plurality of metadata properties included in the metadata property set corresponding to the media content is modified. For example, when the type information on the location of media content is modified, the metadata of the media content may be modified, which may be the case where one of the plurality of metadata properties of the media content is modified.

In the case where the metadata of the media content stored in the server 200 is modified, the server 200 transmits the metadata change information message to the control device 100 in response to the modification to the metadata (operation S409). The metadata change information message may include the metadata change notification information and the metadata change value information.

The control device 100 checks media content of which the metadata has been modified and the type information of a modified metadata property using the metadata change information message received from the server 200 (operation S411). The control device 100 may check media content of which the metadata has been modified using the identifier of media content included in the metadata change notification information, and may check the type information of a modified metadata property among the plurality of metadata properties of the media content identified by the identifier.

Thereafter, the control device 100 checks whether the modified metadata property affects the playback of media content, on the basis of the type information of the modified metadata property (operation S413).

If it is checked that the modified metadata property affects the playback of media content, the control device 100 outputs that media content of which the metadata has been modified is unable to be played (operation S415). This operation will be described with reference to FIG. 4.

In the case where the modified metadata property is the type information on the location of media content that affects the playback of media content, and the media content of which the metadata has been modified is the video content Movie02, the control device 100 may output through the user screen that the media content of which the metadata has been modified is unable to be played. That is, as illustrated in FIG. 4B, the control device 100 may output that the video content Movie02 is temporarily unable to be played by displaying the wording “Temporarily Unavailable” at one side of the title of the video content. Therefore, the user may intuitively and easily apprehend that the video content is currently unable to be played. The control device 100 may output that the media content of which the metadata has been modified is unable to be played, until the modified metadata of the media content is applied to the content list.

Meanwhile, if it is confirmed that the modified metadata property does not affect the playback of media content, the control device 100 may output that the playback of the video content is available as illustrated in FIG. 4A.

FIG. 5 will be described again.

The control device 100 applies the metadata change value information received from the server 200 to a corresponding media content in a stored media content list (operation S417).

Thereafter, the control device 100 outputs that the media content to which the metadata change value information is applied is able to be played (operation S419). For example, referring to FIG. 4, in the case where the value of the modified metadata property of the video content Movie02 is applied to the media content list, the control device 100 may delete the indication that the playback of media content is unavailable, and may output that the video content to which the value of the modified metadata property is applied is able to be played as illustrated in FIG. 4A. Alternatively, in the case where the value of the modified metadata property of the video content Movie02 is applied to the media content list, the control device 100 may display the wording “available” at one side of the title of the video content. Therefore, the user may intuitively and easily apprehend that the updating of media content of which the metadata has been modified is completed.

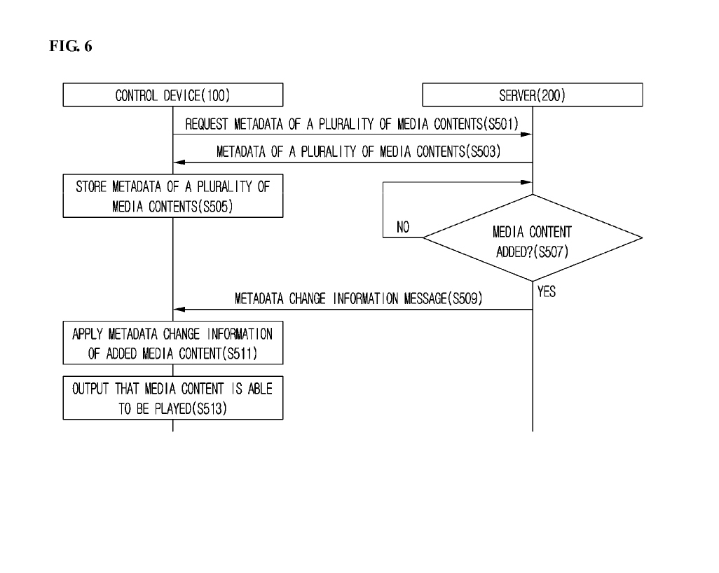

A method for operating a control device and a server according to another embodiment will be described with reference to FIG. 6.

In particular, FIG. 6 illustrates an embodiment in which, in the case where new media content is added to the server 200 and thus the metadata of the media content is added, the server 200 transmits the metadata change information message to the control device 100.

Referring to FIG. 6, the control device 100 requests the metadata of a plurality of media contents from the server 200 (operation S501).

In response to the request of the control device 100 for the metadata of the plurality of metadata, the server 200 transmits the metadata of the plurality of media contents to the control device 100 (operation S503), and the control device 100 stores the metadata of the plurality of media contents received from the server 200 (operation S505).

Thereafter, the server 200 checks whether new media content is added in addition to the plurality of media contents (operation S507). In one embodiment, the case where media content is added may be the case where new media content is uploaded and added to the server 200 and may include the case where the meta data property set of the media content is added. That is, the case where media content is added may not include the case where the metadata property set of the media content stored in the server 200 is modified, but may include the case where new media content is uploaded and added to the server 200 and the metadata property set of the new media content is added.

When it is determined that new media content has been added, the server 200 transmits the metadata change information message in response to the addition of the new media content (operation S509). In this case, the metadata change information message may include the metadata change notification information and the metadata change value information, wherein the metadata change notification information may indicate that there is the metadata of new media content added to the server 200. In this case, the metadata change notification information may include information on the identifier of the newly added media content, and the metadata change value information may include information on the type of the metadata property of the newly added media content and the value of the metadata property of the newly added media content.

The metadata change value information may include information on the identifier of the added media content, the plurality of metadata properties of the media content identified by the identifier, and all the values of the metadata properties of the media content identified by the identifier.

The control device 100 applies the metadata change information of the added media content to the media content list stored in the control device 100 using the received metadata change information message (operation S511).

Thereafter, according to the application of the metadata of the added media content, the control device 100 outputs that the playback of the media content is available (operation S513).

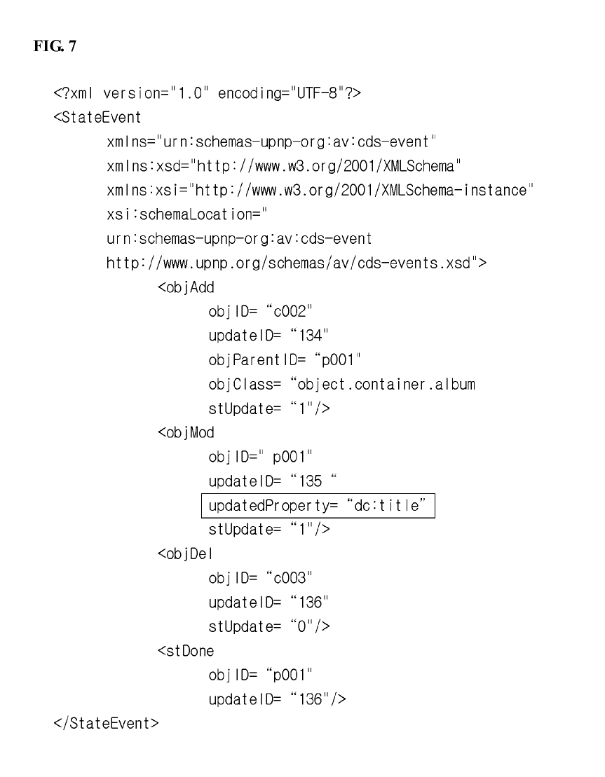

FIGS. 7 to 12 are diagrams illustrating XML schemas of data transmitted from a server to a control device according to an embodiment. Formats of data transmitted from the server 200 to the control device 100 according to various embodiments will be described with reference to FIGS. 7 to 12.

Hereinafter, it is assumed that an object has the same meaning as media content.

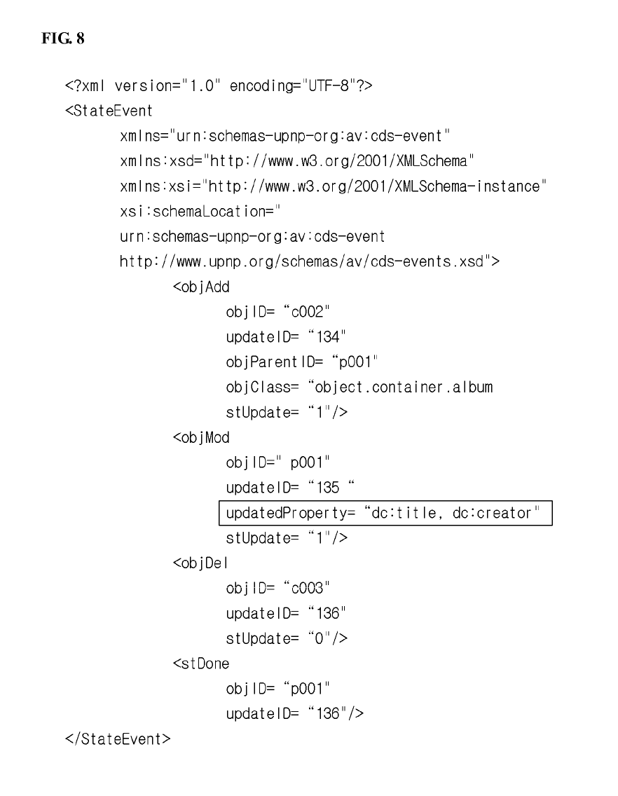

FIGS. 7 and 8 are diagrams illustrating an XML schema of the metadata change notification information transmitted from the server 200 to the control device 100 when it is checked that an object of which the metadata has been modified exists.

The server 200 may periodically transfer the metadata change notification information to the control device 100 so as to notify what object has the metadata that has been changed. That is, the server 200 may periodically transfer the metadata change notification information to the control device 100 so as to notify what object has the metadata that has been changed, what object has been added and what object has been deleted.

In one embodiment, when the server 200 transmits the metadata change notification information to the control device 100, a state variable LastChange may be used. The state variable LastChange is used to notify that the metadata of an object has been changed. A data format of the state variable LastChange according to an embodiment may further include an attribute updatedProperty in an element objMod described below.

In another embodiment, when the server 200 transmits the metadata change notification information to the control device 100, a new state variable M-LastChange may be used.

The state variable LastChange may have the same data format as that of the state variable M-LastChange.

The data format of the state variable LastChange may include an XML header <?xml version=1.0″?> and a root element <state event>.

The XML header may include XML version information.

The root element notifies whether the metadata of a specific object is changed.

The root element may include an element objAdd, an element objMod, an element objDel and an element stDone.

The element objAdd may notify that one object has been added to a content directly service of the server 200.

The objAdd element may include an attribute objID, an attribute updateID, an attribute objParentID, an attribute objClass and an attribute stUpdate.

The attribute objID may indicate an identifier of an added object, the attribute updateID may indicate a result value of a system update identifier SystemUpdateID, the attribute objParentID may indicate an identifier of a parent object of the added object, the attribute objClass may indicate a class of an object, and the attribute stUpdate may indicate whether or not the object has been added as a part of a subtree update operation. If the value of the attribute stUpdate is 1, the attribute stUpdate may indicate that the object is added as a part of the subtree update operation. If the value of the attribute stUpdate is 0, the attribute stUpdate may indicate that the object is not added as a part of the subtree update operation.

The element objMod may notify that the metadata of an object existing in the content directory service of the server 200 has been modified.

The element objMod may include the attribute objID, the attribute updateID, the attribute updatedProperty and the attribute stUpdate.

The attribute objID indicates the identifier of an added object, and the attribute updateID indicates the result value of the system update identifier SystemUpdateID.

The attribute updatedProperty may indicate what metadata property has been modified among a plurality of metadata properties corresponding to an object. That is, since the attribute updatedProperty illustrated in FIG. 7 has a value of “dc:title”, the attribute updatedProperty may indicate that the type information of a title of an object having an object ID of p001 has been modified. In the case where the title and creator of the object having an object ID of p001 are modified, the attribute updatedProperty may have a value of “dc:title, dc:creator” so as to indicate that the title and creator of the object have been modified, as illustrated in FIG. 8.

In the embodiment of FIGS. 7 and 8, only the value of a modified metadata property is transmitted to the control device 100 using the state variable LastChange or the state variable M-LastChange, instead of transmitting all the values of the metadata properties of a modified object (or media content) to the control device 100. Therefore, the size of transmitted metadata may be reduced, thereby reducing unnecessary transmission of data. Therefore, the network traffic may be reduced, and network resources may be saved.

The attribute stUpdate may indicate whether or not an object has been modified as a part of the subtree update operation. If the value of the attribute stUpdate is 1, the attribute stUpdate may indicate that the object is modified as a part of the subtree update operation. If the value of the attribute stUpdate is 0, the attribute stUpdate may indicate that the object is not modified as a part of the subtree update operation.

The element objDel may notify that the metadata of an object existing in the content directory service of the server 200 has been deleted.

The objDel element may include the attribute objID, the attribute updateID and the attribute stUpdate.

The attribute objID may indicate the identifier of an added object, the attribute updateID may indicate the result value of the system update identifier SystemUpdateID, and the attribute stUpdate may indicate whether or not the object has been deleted as a part of the subtree update operation. If the value of the attribute stUpdate is 1, the attribute stUpdate may indicate that the object has been deleted as a part of the subtree update operation. If the value of the attribute stUpdate is 0, the attribute stUpdate may indicate that the object has not been deleted as a part of the subtree update operation.

The element stDone may indicate whether the subtree update operation has been completed.

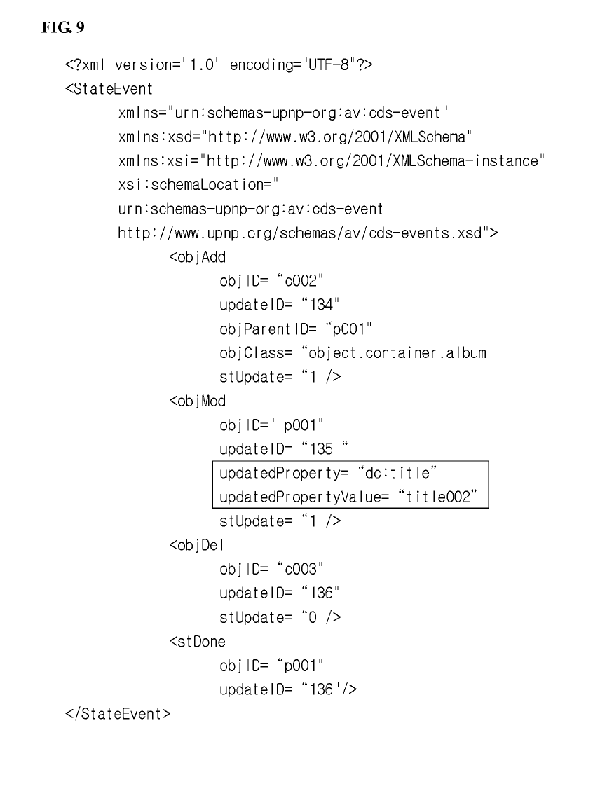

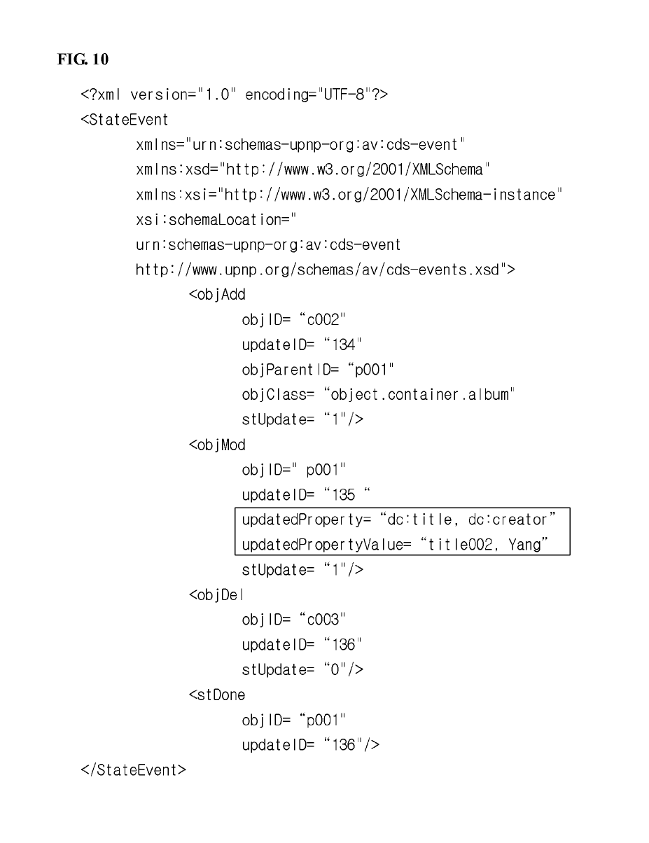

Formats of data transmitted from the server 200 to the control device 100 according to an embodiment will be described with reference to FIGS. 9 and 10.

In particular, FIGS. 9 and 10 illustrate an XML schema for the metadata change information message including the metadata change notification information and the metadata change value information transmitted from the server 200 to the control device 100 when it is checked that an object of which the metadata has been modified exists.

Hereinafter, it is assumed that an object has the same meaning as media content.

The server 200 may periodically transfer the metadata change information message to the control device 100 so as to notify what object has the metadata that has been changed. That is, the server 200 may periodically transfer the metadata change information message to the control device 100 so as to notify what object has the metadata that has been changed, what object has been added and what object has been deleted.

In one embodiment, when the server 200 transmits the metadata change information message to the control device 100, the state variable LastChange may be used. The state variable LastChange is used to notify that the metadata of an object has been modified. A data format of the state variable LastChange according to an embodiment may further include an attribute updatedProperty and an attribute updatedPropertyValue in an element objMod described below.

In another embodiment, when the server 200 transmits the metadata change value information to the control device 100, a new state variable M-LastChange may be used.

The state variable LastChange may have the same data format as that of the state variable M-LastChange.

Descriptions of the data format of the state variable LastChange or state variable M-LastChange which overlap with the descriptions provided above with reference to FIGS. 7 and 8 will be omitted, and the following description is focused on the element objMod.

Referring to FIG. 9, the element objMod may include the attribute objID, the attribute updateID, the attribute updatedProperty, an attribute updatePropertyValue and the attribute stUpdate.

The attribute updatedProperty may indicate what metadata property has been modified among a plurality of metadata properties corresponding to an object. That is, since the attribute updatedProperty illustrated in FIG. 9 has a value of “dc:title”, the attribute updatedProperty may indicate that the type information of a title of an object having an object ID of p001 has been modified. In the case where the title and creator of the object having an object ID of p001 are modified, the attribute updatedProperty may have a value of “dc:title, dc:creator” so as to indicate that the title and creator of the object have been modified, as illustrated in FIG. 10.

The attribute updatePropertyValue may indicate a value of a modified metadata property. That is, the attribute updatePropertyValue may indicate a value of a modified metadata property among a plurality of metadata properties corresponding to an object. FIG. 9 illustrates that the attribute updatedProperty has a value of “dc:title” so as to indicate that a title of an object having an object ID of p001 has been modified, and a value of the attribute updatePropertyValue is changed to title002 as the title of the object having an object ID of p001 is modified.

FIG. 10 illustrates that the attribute updatedProperty has a value of “dc:title, dc:creator” so as to indicate that the title of the object having an object ID of p001 has been modified and the creator of the object has been changed to “dc:creator”, and the value of the attribute updatePropertyValue for the title of the object is changed to title002 as the title of the object having an object ID of p001 is modified, and the value of the attribute updatePropertyValue for the creator of the object is changed to “title002, Yang”.

In the embodiment of FIGS. 9 and 10, only modified metadata is transmitted to the control device 100 using the state variable LastChange or the state variable M-LastChange, instead of transmitting the entire metadata of a modified object (or media content) to the control device 100. Therefore, the size of transmitted metadata may be reduced, thereby reducing unnecessary transmission of data. Therefore, the network traffic may be reduced, and network resources may be saved.

Furthermore, the control device 100 does not need to perform an additional process after receiving the metadata change information message, thereby reducing the network traffic and saving network resources.

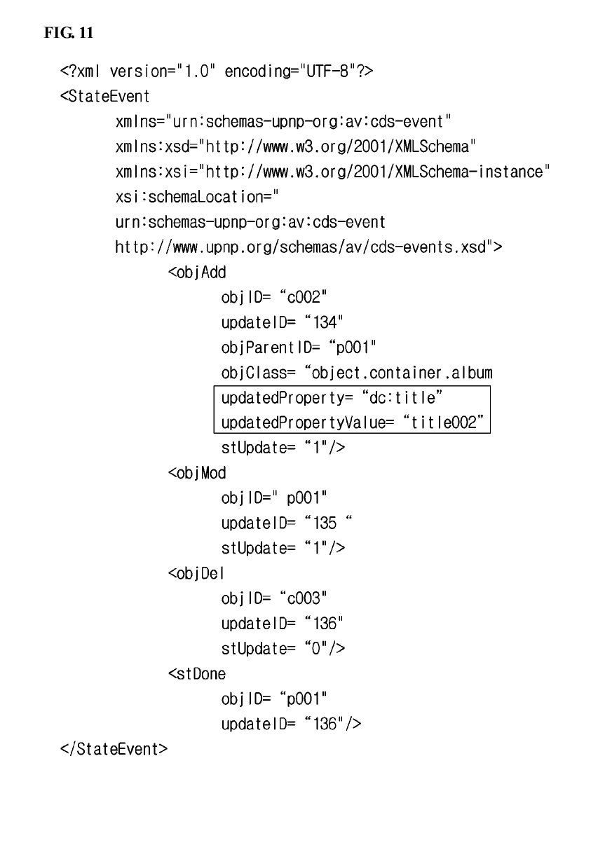

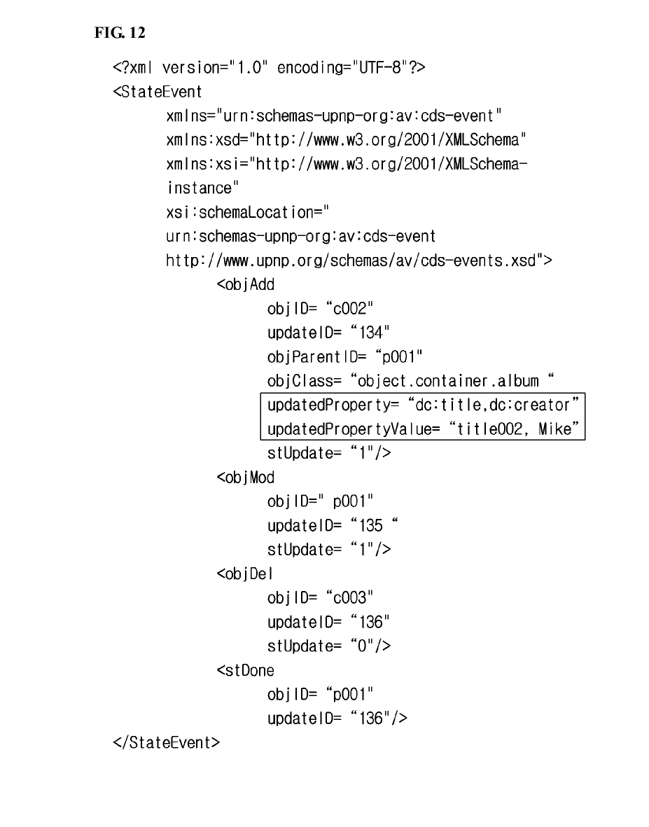

Formats of data transmitted from the server 200 to the control device 100 according to another embodiment will be described with reference to FIGS. 11 and 12.

In particular, FIGS. 11 and 12 illustrate an XML schema of the metadata change information message transmitted from the server 200 to the control device 100 when a new object is added to the server 200.

The server 200 may periodically transfer the metadata change information message to the control device 100 so as to notify what object has the metadata that has been changed. That is, the server 200 may periodically transfer the metadata change information message to the control device 100 so as to notify what object has the metadata that has been changed, what object has been added and what object has been deleted.

In one embodiment, when the server 200 transmits the metadata change value information to the control device 100, the state variable LastChange may be used. The state variable LastChange is used to notify that the metadata of an object has been changed. A data format of the state variable LastChange according to another embodiment may further include an attribute updatedProperty and an attribute updatedPropertyValue in an element objAdd described below.

In another embodiment, when the server 200 transmits the metadata change information message to the control device 100, a new state variable M-LastChange may be used.

The state variable LastChange may have the same data format as that of the state variable M-LastChange.

Descriptions of the data format of the state variable LastChange or state variable M-LastChange which overlap with the descriptions provided above with reference to FIGS. 7 and 8 will be omitted, and the following description is focused on the element objAdd.

Referring to FIG. 11, the element objAdd may include the attribute objID, the attribute updateID, the attribute updatedProperty, an attribute updatePropertyValue and the attribute stUpdate.

The attribute updatedProperty may indicate a specific metadata property among a plurality of metadata properties corresponding to an added object. That is, since the attribute updatedProperty illustrated in FIG. 11 has a value of “dc:title”, so as to indicate the type information of a title of the added object having an object ID of p001. If the attribute updatedProperty has a value of “dc:title, dc:creator” as illustrated in FIG. 12, the attribute updatedProperty may indicate the type information of the title of the added object and the type information of the creator of the added object.

The attribute updatePropertyValue may indicate a value of a metadata property of the added object. That is, the attribute updatePropertyValue may indicate a value of a metadata property included in the attribute updatedProperty among a plurality of metadata properties corresponding to the added object. FIG. 11 illustrates that the value of the attribute updatePropertyValue indicates that the value of the metadata property of the title of the added object having an object ID of c002 is title002.

FIG. 12 illustrates that the type information of the title of the object having an object ID of c002 and the type information of the creator of the object are indicated using the attribute updatedProperty, the value of the metadata property of the title of the object is title 002, and the value of the metadata property of the creator of the object is Yang.

In the embodiment of FIGS. 11 and 12, the server 200 transmits, to the control device 100, only the metadata property set of a newly added object other than the metadata of all objects (or media content) stored in the server 200 using the state variable LastChange or the state variable M-LastChange. Therefore, the size of transmitted metadata may be reduced, thereby reducing unnecessary transmission of data. Therefore, the network traffic may be reduced, and network resources may be saved.

Furthermore, the control device 100 does not need to perform an additional process after receiving the metadata change value information, thereby reducing the network traffic and saving network resources.

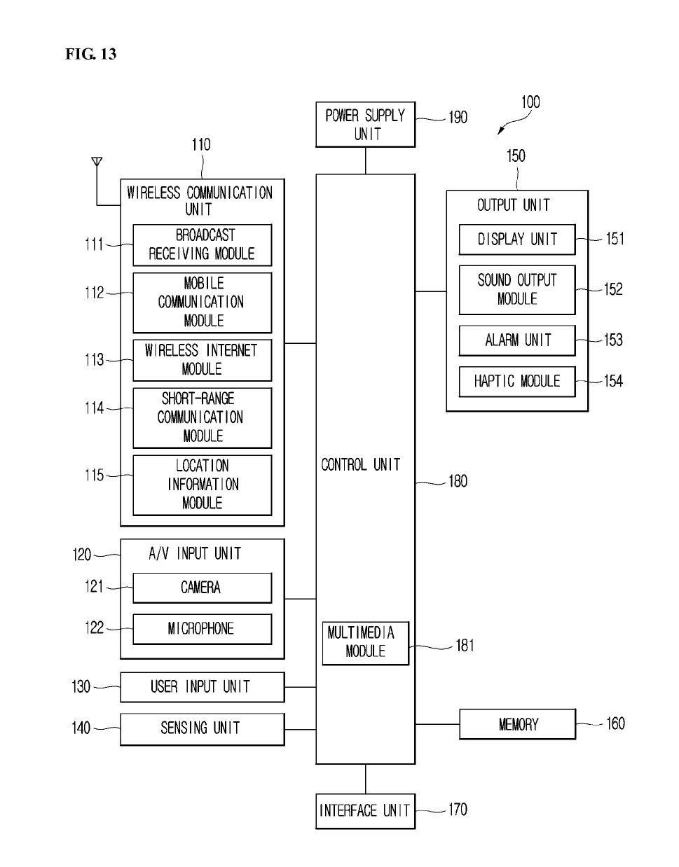

FIG. 13 is a block diagram illustrating devices according to an embodiment.

For convenience, the control device 100 and the server 200 may be referred to as terminals.

The control device 100 may include a wireless communication unit 110, an audio/video (A/V) input unit 120, a user input unit 130, a sensing unit 140, an output unit 150, a memory 160, an interface unit 170, a control unit 180, and a power supply unit 190. The elements illustrated in FIG. 13 are not necessarily essential, and thus, more elements may be added or some elements may be omitted.

Hereinafter, the above-mentioned elements will be described.

The wireless communication unit 110 may include at least one module that enables wireless communication between the control device 100 and a wireless communication system or between the control device 100 and a network where the control device 100 is located. For example, the wireless communication unit 110 may include at least one broadcast receiving module 111, at least one mobile communication module 112, at least one wireless Internet module 113, at least one short-range communication module 114, and at least one location information module 115.

Although the above-mentioned communication system employs a wireless communication technology, the communication system may be constructed using a wired communication technology.

The terminal may access a network through such communication modules.

In particular, in an embodiment, the wireless communication unit 110 may be controlled by the control unit 180 so as to transmit or receive the above-mentioned messages or device information using a multicast or unicast technique. Collected device information is stored in the memory 160.

The broadcast receiving module 111 receives, from an external broadcast management server, a broadcast signal and/or broadcast-related information through a broadcast channel.

The broadcast channel may include a satellite channel and a terrestrial channel. The broadcast management server may represent a server that generates and transmits the broadcast signal and/or the broadcast-related information, or a server that receives a pre-generated broadcast signal and/or broadcast-related information and transmits the received broadcast signal and/or broadcast-related information to the terminal. The broadcast signal may include not only a TV broadcast signal, a radio broadcast signal, and a data broadcast signal but also a broadcast signal obtained by combining the TV or radio broadcast signal with the data broadcast signal.

The broadcast-related information may represent information related to a broadcast channel, a broadcast program, or a broadcast service provider. The broadcast-related information may also be provided through a mobile communication network. In this case, the broadcast-related information may be received by the mobile communication module 112.

The broadcast-related information may have various formats. For example, the broadcast-related information may have a format of an electronic program guide (EPG) of digital multimedia broadcasting (DMB) or an electronic service guide (ESG) of a digital video broadcast-handheld (DVB-H).

The broadcast receiving module 111 may receive a digital broadcast signal using a digital broadcasting system such as digital multimedia broadcasting-terrestrial (DMB-T), digital multimedia broadcasting-satellite (DMB-S), media forward link only (MediaFLO), digital video broadcast-handheld (DVD-H), or integrated services digital broadcast-terrestrial (ISDB-T). The broadcast receiving module 111 may also be configured to be suitable for other broadcasting systems.

The broadcast signal and/or the broadcast-related information received through the broadcast receiving module 111 may be stored in the memory 160.

The mobile communication module 112 transmits/receives radio signals to/from at least one of a base station, an external terminal, and a server on the mobile communication network. The radio signal may include various types of data according to transmission of a voice call signal, a video call signal, or text/multimedia messages.

The wireless Internet module 113 represents a module for wireless Internet access, and may be installed in the control device 100 or outside the control device 100. A wireless internet technology such as wireless LAN (WLAN) (Wi-wi), wireless broadband (Wibro), world interoperability for microwave access (Wimax), or high speed downlink packet access (HSDPA) may be used.

In particular, in an embodiment, the control unit 180 accesses the ISN or the WFDN through the wireless Internet module 113. When the number of accessible networks is smaller than that of the wireless Internet modules 113, the control unit 180 disconnects from a network connected through one wireless Internet module 113 so as to access another network.

The short-range communication module 114 represents a module for short-range communication. A short-range communication technology such as Bluetooth, radio frequency identification (RFID), infrared data association (IrDA), ultra wideband (UWB), or ZigBee may be used.

The location information module 115 serves to determine a location of the terminal, and for example, a global positioning system (GPS) module may be used.

Referring to FIG. 13, the A/V input unit 120 is for inputting an audio signal or a video signal, and may include a camera 121 and a microphone 122. The camera 121 processes image frames of still images or video obtained by an image sensor in a video call mode or an image-capturing mode. The processed image frames may be displayed on a display unit 151.

The image frames processed in the camera 121 may be stored in the memory 160 or may be transmitted to the outside through the wireless communication unit 110. Two or more cameras 121 may be provided according to a use environment.

The microphone 122 receives and processes an external sound signal to obtain electrical voice data, in a call mode, a recording mode, or a voice recognition mode. In the case of the call mode, the voice data may be converted into a format that enables transmission to a mobile communication base station through the mobile communication module 112. Various noise elimination algorithms may be applied to the microphone 122 to eliminate noise generated while the external sound signal is received.

The user input unit 130 allows the user to generate input data for controlling an operation of the terminal. The user input unit 130 may include a keypad, a dome switch, a touchpad (resistive/capacitive type), a jog wheel, and a jog switch.

The sensing unit 140 detects a current state of the control device 100, more specifically, detects, for example, whether the control device 100 is opened/closed and whether the user contacts the control device 100, and detects an orientation and acceleration/deceleration of the terminal. Then, the sensing unit 140 generates a sensing signal for controlling an operation of the control device 100. For example, in the case where the control device 100 is a slide-type phone, it may be sensed whether the phone is opened/closed. Furthermore, it may be sensed whether power is supplied by the power supply unit 190 and whether the interface unit 170 is connected to an external device. The sensing unit 140 may include a proximity sensor 141.

The output unit 150 serves to generate visual, auditory, and tactile outputs. The output unit 150 may include the display unit 151, a sound output module 152, an alarm unit 153, and a haptic module 154.

The display unit 151 displays (outputs) information processed in the control device 100. For example, in the case where the terminal is in the call mode, the display unit 151 displays a user interface (UI) or graphic user interface (GUI) related to a call. In the case where the control device 100 is in the video call mode or the image-capturing mode, the display unit 151 displays the UI, GUI, or images captured and/or received.

The display unit 151 may include at least one of a liquid crystal display (LCD), a thin film transistor-liquid crystal display (TFT LCD), an organic light-emitting diode (OLED), a flexible display, and a 3D display.

Some of the displays may be transparent or light transmissive displays. Such a display may be referred to as a transparent display. The transparent display includes, for example, a transparent OLED (TOLED). A rear structure of the display unit 151 may also be light transmissive. Due to such structures, a user may view an object located at the back of a body of the terminal through an area of the display unit 151 of the terminal.

According to the type of the control device 100, two or more display units 151 may be provided. For example, in the control device 100, a plurality of display units may be arranged integrally or separately on a single surface or may be arranged on different surfaces respectively.

In the case where the display unit 151 and a sensor for sensing a touch motion (hereinafter referred to as a touch sensor) form a layer structure (hereinafter referred to as a touch screen), the display unit 151 may be used as both an output device and an input device. The touch sensor may include, for example, a touch film, a touch sheet, and a touch pad.

The touch sensor may be configured so that a change in a pressure on a specific site of the display unit 151 or a change in a capacitance of a specific site of the display unit 151 is converted to an electric input signal. The touch sensor may be configured so as to detect not only a location and an area of a touch but also a pressure of the touch.

When a touch input is performed on the touch sensor, signal(s) corresponding to the touch input is (are) transmitted to a touch controller. The touch controller processes the signal(s) and then transmits corresponding data to the control unit 180. In this manner, the control unit 180 may recognize what region of the display unit 151 has been touched.

Referring to FIG. 13, the proximity sensor 141 may be arranged in an internal area of the terminal surrounded by the touch screen or in the vicinity of the touch screen. The proximity sensor 141 represents a sensor that detects an object approaching a certain detection surface or an object located near the sensor using the force of an electromagnetic field or infrared rays without mechanically contacting the object. The proximity sensor 141 has a longer life than that of a contact-type sensor and may be widely applied.

The proximity sensor 141 may include, for example, a transmissive photoelectric sensor, a direct reflection-type photoelectric sensor, a mirror reflection-type photoelectric sensor, a high-frequency oscillation-type proximity sensor, a capacitive-type proximity sensor, a magnetic proximity sensor, and an infrared proximity sensor. In the case where the touch screen is a capacitive type, an approach of the pointer is detected due to a change in an electric field. In this case, the touch screen (touch sensor) may be classified as a proximity sensor.

Hereinafter, for convenience, “proximity touch” represents an act of locating the pointer on the touch screen without making a contact therewith, and “contact touch” represents an act of making the pointer directly contact the touch screen. The location for the proximity touch represents such a location where the pointer vertically corresponds to the touch screen when the pointer makes the proximity touch.

The proximity sensor detects the proximity touch and a proximity touch pattern (e.g. a proximity touch distance, a proximity touch direction, a proximity touch speed, a proximity touch time, a proximity touch location, a proximity touch movement state, etc). Information corresponding to the detected proximity touch motion and the proximity touch pattern may be output through the touch screen.

The sound output module 152 may output audio data received from the wireless communication unit 110 or stored in the memory 160 in a call signal receiving mode, a call mode, a recording mode, a voice recognition mode, or a broadcast receiving mode. The sound output module 152 may output a sound signal related to a function performed in the control device 100 (e.g. a call signal receiving sound, a message receiving sound, etc). The sound output unit 152 may include a receiver, a speaker, a buzzer, and the like.

The alarm unit 153 outputs a signal for notifying an event occurrence of the control device 100. The event that occurs in the terminal may include, for example, call signal reception, message reception, key signal input, and touch input. The alarm unit 153 may output the signal for notifying the event occurrence in a different form from a video or audio signal, such as vibration. The video signal or audio signal may also be output through the display unit 151 or the sound output module 152. Therefore, the display unit 151 or the sound output module 152 may be classified as a part of the alarm unit 153.

The haptic module 154 generates various tactile effects that may be felt by a user. The tactile effect generated by the haptic module 154 includes, for example, vibration. An intensity and a pattern of the vibration generated by the haptic module 154 may be controlled. For example, different vibrations may be synthesized to be output, or may be sequentially output.

In addition to the vibration effect, the haptic module 154 may generate various tactile effects caused by a pin arrangement vertically moving on a contact skin surface, jet or suction of air through a jet or suction hole, sweeping on a skin surface, contact of an electrode, and stimulation by electrostatic force, or effects of giving feeling of warmth/coldness using a heat-absorbing or heating device.

The haptic module 154 may be configured so as to give the tactile effects to a user not only through a direct contact but also through muscle sense of a finger or an arm. Two or more haptic modules 154 may be provided according to configuration of the terminal.

The memory 160 may store a program for operating the control unit 180 and may temporarily store input/output data (e.g. phonebooks, messages, still images, videos, etc). The memory 160 may store data on various patterns of vibration and sound output when the touch input performed on the touch screen.

The memory 160 may include at least one of storage media such as a flash memory, a hard disk, a multimedia card micro type, a card-type memory (e.g. SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The control device 100 may be operated in association with a web storage for performing a storage function of the memory 160 on the Internet.

The interface unit 170 serves as a passage to all external devices connected to the control device 100. The interface unit 170 receives data from the external devices, delivers power to each element in the control device 100, or allows data in the control device 100 to be transmitted to the external devices. For example, the interface unit 170 may include a wired/wireless headset port, an external charger port, a wired/wireless data port, a memory card port, a port for connecting a device having an identification module, an audio input/output (I/O) port, a video I/O port, and an earphone port.

The identification module stores various information for authenticating a right to use the control device 100. The identification module may include a user identify module (UIM), a subscriber identity module (SIM), and a universal subscriber identity module (USIM). The device having the identification module (hereinafter referred to as an identification device) may be manufactured in the form of a smart card. Thus, the identification device may be connected to the terminal through a port.

The interface unit may be a passage for supplying power from an external cradle to the terminal when the terminal is connected to the cradle. The interface unit may be a passage for transmitting various command signals that are input to the cradle by the user to the terminal. The various command signals or the power input from the cradle may serve as signals for recognizing whether the terminal is correctly mounted on the cradle.

The control unit 180 controls overall operation of the terminal. For example, the control unit 180 performs a control operation and a processing operation related to a voice call, data communication, and a video call. The control unit 180 may be provided with a multimedia module 181 for playing multimedia. The multimedia module 181 may be installed in the control unit 180 or may be separated from the control unit 180.

The control unit 180 performs the determinations and decisions described above with reference to FIGS. 1 to 15. That is, the control unit 180 may perform the operations illustrated in FIGS. 1 to 15, while controlling the wireless communication unit 110.

The control unit 180 may perform a pattern recognition process for recognizing characters and images from handwriting input or picture drawing input performed on the touch screen.

The power supply unit 190 receives external power and internal power and supplies power required for operating each element, according to control by the control unit 180.

The various embodiments described herein may be implemented, for example, in a recording medium readable by a computer or the like using software, hardware, or a combination thereof.

For implementation with hardware, the embodiments described herein may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and other electric units. In some cases, such embodiments may be implemented by the control unit 180.

For implementation with software, an embodiment related to a procedure or a function may be implemented with a separate software module for performing at least one function or operation. A software code may be implemented by a software application coded by an appropriate programming language. The software code may be stored in the memory 160 and may be executed by the control unit 180.

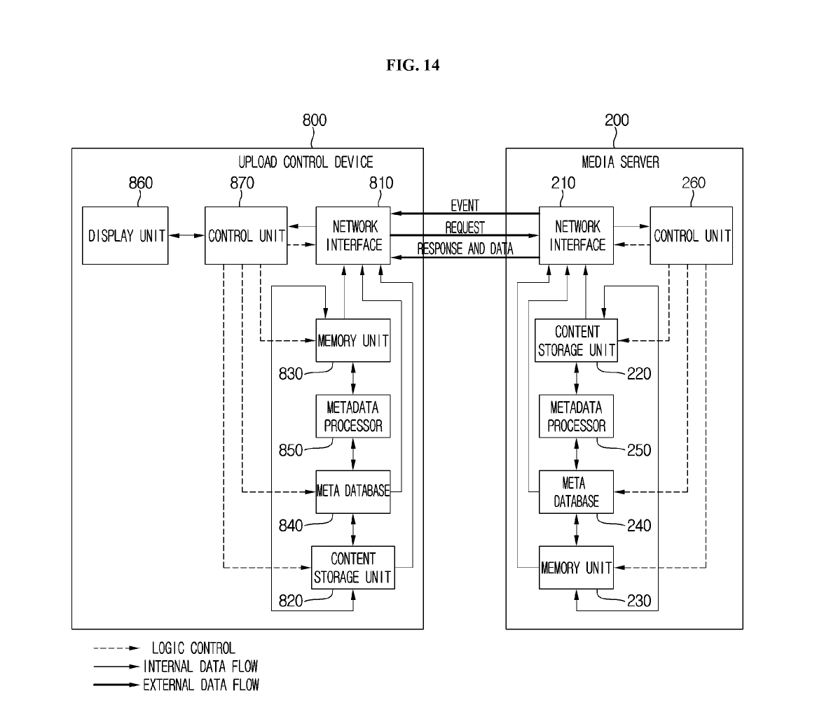

2-box box model devices will be described with reference to FIG. 14.

FIG. 14 is a block diagram illustrating a 2-box model device according to an embodiment.

The 2-box model device may include an upload control device 800 and a server 200.

The upload control device 800 may correspond to the control device 100 described above with reference to FIGS. 1 to 12.

Referring to FIG. 14, the upload control device 800 may include a network interface 810, a content storage unit 820, a memory unit 830, a meta database 840, a metadata processor 850, a display unit 860 and a control unit 870.

The upload control device 800 may transmit a request message and an action message to the server 200 so that content stored in the upload control device 800 or the server 200 is transmitted to another server 200.

The network interface 810 may receive information from a network, and may transmit information stored in the memory unit 830, the meta database 840 and the content storage unit 820 to the network.

The network interface 810 may transmit/receive event message, request messages, response messages and data between the upload control device 800 and the server 200 via the network.

The content storage unit 820 may store a content list. The content storage unit 820 may include a hard disk-type storage medium.

The memory unit 830 is a physical device for temporarily storing various data including content.

The memory unit 830 may perform a function for temporarily storing data received from the network interface 810.

The memory unit 830 may include at least one of a flash memory type, a multimedia card micro type, a card-type memory (e.g., SD or XD memory), RAM and ROM (e.g., EEPROM).

The meta database 840 stores the metadata of stored content. The metadata of content may be data about a name, size, storage location, contents, creator information, use history, format information and profile name of the content.

In the case where the metadata processor 850 is implemented in the server 200, the metadata processor 850 may extract the metadata of the content stored in the server 200.

In the case where the metadata processor 850 is implemented in the upload control device 800, the metadata processor 850 may type the metadata of content received from the server 200. The metadata processor 850 may allow the typed data to be displayed.

The control unit 870 may control overall operation of the upload control device 800 or the server 200.

The control unit 870 may receive a user input and may control the control device 800 so that an operation corresponding to the user input is performed.

The display unit 850 may display various types of data including a content list.

The display unit 850 may indicate a device from which the profile name of specific content has been extracted.

The server 200 receives the request message and the action message from the upload control device 800 so as to perform operations corresponding to the messages.

The server 200 may transmit an event message to the upload control device 800, and may transmit a response message to the upload control device 800 upon receiving a request message from the upload control device 800.

The server 200 may include a network interface 210, a content storage unit 220, a memory unit 230, a meta database 240, a metadata processor 250 and a control unit 260, of which the functions are basically the same as described above with reference to FIG. 13.

The network interface 810 may include the functions of the wireless communication unit 110 described above with reference to FIG. 13.

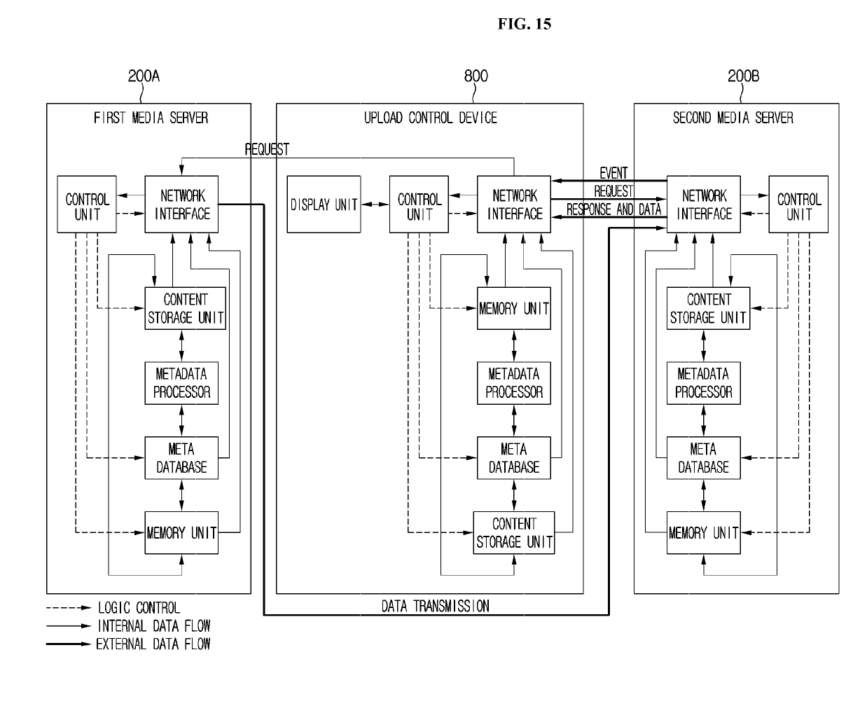

The content storage unit 820, the memory unit 830 and the meta database 840 may include the functions of the memory 160 described above with reference to FIG. 15.

The display unit 860 may include the functions of the display unit 151 described above with reference to FIG. 13.

The meta data processor 850 may be included in the control unit 870, and the control unit 870 may include the functions of the control unit 180 described above with reference to FIG. 13.

3-box box model devices will be described with reference to FIG. 15.

FIG. 15 is a block diagram illustrating a 3-box model device according to an embodiment.

The 3-box model device may include an upload control device 800, a first server 200A and a second server 200B.

Since the configurations of the upload control device 800, the first server 200A and the second server 200B are the same as described above with reference to FIG. 14, detailed descriptions of the upload control device 800, the first server 200A and the second server 200B are omitted.

The upload control device 800 may transmit a request message for transmitting data stored in the first server 200A to the second server 200B. The first server 200A may receive the request message from the upload control device 800, and may transmit data to the second server 200B. According to this operation, the upload control device 800 may control the first server 200A so that content stored in the first server 200A is uploaded to the second server 200B.

According to an embodiment, the above-mentioned method may be implemented as processor-readable codes in a program-recorded medium. A processor-readable recording medium includes, for example, a ROM, a RAM, a CD-ROM, a magnetic tape, a floppy disk, and an optical data storage device, and may also be implemented in the form of a carrier wave (for example, transmission via the Internet).

The above-mentioned devices are not limited to the configuration and methods of the above-mentioned embodiments. The entirety or part of each embodiment may be selectively combined with each other to make various medications.

1. A method for operating a server controlled by a control device, the method comprising:
determining whether metadata of media content has been changed; and
transmitting a metadata change information message to the control device when it is determined that the metadata of the media content has been changed,
wherein the metadata change information message comprises metadata change notification information for notifying that the metadata of the media content has been changed.

2. The method according to claim 1, wherein the metadata change notification information comprises an identifier of the media content of which the metadata has been changed and a type of a changed metadata property among a plurality of metadata properties of the media content identified by the identifier.

3. The method according to claim 2, wherein the metadata change notification information does not comprise a type of a metadata property that has not been changed among the plurality of metadata properties of the media content identified by the identifier.

4. The method according to claim 2, wherein the metadata change information message comprises metadata change value information, wherein the metadata change value information comprises an identifier of the metadata change notification information and a changed value of a metadata property corresponding to a type of a metadata property of the metadata change notification information.

5. The method according to claim 4, wherein the metadata change value information does not comprise a value of a metadata property corresponding to a type of an unchanged metadata property of the media content identified by the identifier.

6. The method according to claim 4, wherein the transmitting step that transmits the metadata change information message to the control device comprises:
checking whether the metadata change value information is set to be transmitted,
wherein if the metadata change value information is set not to be transmitted, the metadata change information message comprises the metadata change notification information, and if the metadata change value information is set to be transmitted, the metadata change information message comprises the metadata change notification information and the metadata change value information.

7. The method according to claim 2, the method further comprising:
receiving, from the control device, a metadata change value request message for requesting metadata change value information; and
transmitting a metadata change value information response message to the control device in response to the metadata change value request message,
wherein the metadata change value information comprises an identifier of the metadata change notification information and a changed value of a metadata property corresponding to a type of a metadata property of the metadata change notification information.

8. The method according to claim 1, wherein the metadata change information message comprises the metadata change notification information and metadata change value information,
wherein the metadata change notification information indicates that new media content is added to the server and there exists metadata of the added media content, the metadata change notification information comprising an identifier of the added media content,
wherein the metadata change value information comprises a plurality of metadata properties of the added media content and values of the plurality of metadata properties.

9. A method for operating a control device for controlling a server, the method comprising:
transmitting, to the server, a request for metadata of a plurality of media contents;
receiving, from the server, the metadata of the plurality of media contents in a response to the request; and
receiving a metadata change information message about whether the metadata of at least one of the plurality of media contents has been changed or whether there exists media content added to the server,
wherein the metadata change information message comprises metadata change notification information for notifying that the metadata of the media content has been changed.

10. The method according to claim 9, wherein when the metadata of at least one of the plurality of media contents is changed, the metadata change notification information comprises an identifier of the media content of which the metadata has been changed and a type of a changed metadata property among a plurality of metadata properties of the media content identified by the identifier.

11. The method according to claim 10, wherein the metadata change information message comprises metadata change value information, wherein the metadata change value information comprises an identifier of the metadata change notification information and a changed value of a metadata property corresponding to a type of a metadata property of the metadata change notification information.

12. The method according to claim 10, comprising:
transmitting, to the server, a metadata change value request message for requesting metadata change value information; and
receiving, from the server, a metadata change value information response message in response to the metadata change value request message,
wherein the metadata change value information comprises an identifier of the metadata change notification information and a changed value of a metadata property corresponding to a type of a metadata property of the metadata change notification information.

13. The method according to claim 10, comprising:
checking whether the type of the changed metadata property affects playback of the media content of which the metadata has been changed, on the basis of the type of the changed metadata property.

14. The method according to claim 13, comprising:
outputting that the playback of the media content of which the metadata has been changed is unavailable, if it is checked that the type of the changed metadata property affects the playback of the media content, and outputting that the playback of the media content of which the metadata has been changed is available, if it is checked that the type of the changed metadata property does not affect the playback of the media content.

15. The method according to claim 9, wherein if there exists media content added to the server, the metadata change information message comprises the metadata change notification information and the metadata change value information,
wherein the metadata change notification information indicates that new media content is added to the server and there exists metadata of the added media content, the metadata change notification information comprising an identifier of the added media content,
wherein the metadata change value information comprises a plurality of metadata properties of the added media content and values of the plurality of metadata properties.

16. A server controlled by a control device, comprising:
a network interface; and
a control unit configured to determine whether metadata of media content has been changed, and to transmit a metadata change information message to the control device through the network interface when it is determined that the metadata of the media content has been changed,
wherein the metadata change information message comprises metadata change notification information for notifying that the metadata of the media content has been changed.

17. A control device for controlling a server, comprising:
a network interface; and
a control unit configured to transmit, to the server, a request for metadata of a plurality of media contents through the network interface, and to receive, from the server, the metadata of the plurality of media contents in a response to the request, and to receive a metadata change information message about whether the metadata of at least one of the plurality of media contents has been changed or whether there exists media content added to the server,
wherein the metadata change information message comprises metadata change notification information for notifying that the metadata of the media content has been changed.
